(19) United States
(12) Patent Application Publication
(10) Pub. No.: US 2026/0191128 A1
(43) Pub. Date: Jul. 9, 2026

(54) BROADCAST SPREADER HAVING A CONTAINER

(71) Applicant: RAUCH Landmaschinenfabrik GmbH, Rheinmuenster (DE)

(72) Inventors: Franz DOLL, Sinzheim (DE); Thomas Markus ZEITVOGEL, Rheinmuenster (DE)

(73) Assignee: RAUCH Landmaschinenfabrik GmbH, Rheinmuenster (DE)

(21) Appl. No.: 19/443,885

(22) Filed: Jan. 8, 2026

(30) Foreign Application Priority Data
Jan. 8, 2025 (DE) 20 2025 100 059.8

(51) Int. Cl. A01C 17/00

(52) U.S. Cl. CPC A01C 17/001; A01C 17/008

(57) ABSTRACT

A broadcast spreader for applying spreading material is proposed, which comprises a container carried by a frame for stockpiling the spreading material, the container having an essentially funnel-like, downwardly tapering section with an outlet opening. Situated downstream from the outlet opening is a metering element, downstream from which, in turn, a spinner disk is situated. The invention provides that the outlet opening is arranged on a separate outlet part of the container, which is detachably fastened to the essentially funnel-like, downwardly tapering section of the container and may be manufactured, for example, from a plastic material, for example in the form of an injection-molded part. It may furthermore be provided that a base of the outlet part provided with the outlet opening is designed as a separate base part, which is fixed to the outlet part.

This nonprovisional application claims priority under 35 U.S.C. § 119(a) to German Patent Application No. 20 2025 100 059.8, which was filed in Germany on Jan. 8, 2025, and which is herein incorporated by reference.

### BACKGROUND OF THE INVENTION

### Field of the Invention

The invention relates to a broadcast spreader for applying spreading material, comprising at least one container carried by a frame for stockpiling the spreading material, the container having at least one essentially funnel-like, downwardly tapering section with at least one outlet opening; at least one metering element situated downstream from the outlet opening; and at least one spinner disk situated downstream from the metering element.

### Description of the Background Art

Broadcast spreaders of the aforementioned type, which are also referred to as centrifugal spreaders, are used extensively, in particular, for agricultural purposes to apply powdery or particulate spreading material, such as fertilizers, lime, seeds, or other particulate solids. In addition to single-disk spreaders, which have only one rotationally driven spinner disk provided with spreading vanes, twin-disk spreaders, in particular, have proven to be successful, which have two spinner disks provided with spreading vanes, which are usually rotationally driven independently of each other. Generic broadcast spreaders exist, for example, in a pulled design, as autonomously driven or walk-along versions, and also as accessory equipment, which may be received by a three-point power lift of a traction engine, such as a tractor. Broadcast spreaders of this type comprises a container, carried by a frame and receiving the spreading material, which usually comprises essentially funnel-like, downwardly tapering sections, on the lower end of which a particular outlet opening is arranged. In the case of twin-disk spreaders, the container comprises two essentially funnel-like, downwardly tapering sections, each having an outlet opening. The or a particular outlet opening is situated downstream from (one) metering element for the purpose of removing the spreading material to be applied from the container in the desired quantity—or, more specifically, with the desired mass flow. The particular metering element usually has a metering slide, which may be opened and closed with the aid of a suitable control element to be able to adjust the desired mass flow, depending on the desired spreading width of the spreading material on the ground, depending on the speed of travel, and depending on the physical properties of the spreading material, such as its pourability. Alternatively, for the same purpose, the metering element may also comprise, for example, a controllably rotationally driven cam cylinder or seed plate cylinder. In the case of modern twin-disk spreaders, the metering elements are usually able to be controlled and/or regulated independently of each other. Spinner disks are situated below the metering element, whose rotational speed may be able to be controlled and/or regulated independently of each other in the case of modern twin-disk spreaders, and which are usually fitted with throwing blades and are used to distribute the powdery or particulate spreading material over the desired working width. The spinner disks, which are generally rotationally driven around vertical rotation axes, generally rotate in opposite directions, the right spinner disk in the direction of travel rotating counterclockwise and the left spinner disk in the direction of travel rotating clockwise when viewing the spinner disks from above.

In the case of winter service spreaders, the container is used primarily to receive generally granular grit, sand, and/or road salt, the function of a winter service spreader of this type largely corresponding to that of an agricultural broadcast spreader described above.

During the so-called normal spreading with the aid of twin-disk spreaders, a uniform spreading density is achieved in agriculture by overlapping the spreader fans spun out by the spinner disks when driving along adjacent lanes. The spreading material is distributed evenly by the spinner disks on both sides of the twin-disk spreader, but with a varying spreading density decreasing from the inside to the outside. Shallow-sloping spreading patterns, such as, in particular, essentially trapezoidal or triangular ones, are particularly suitable for achieving a uniform spreading density, the spreading patterns overlapping during subsequent travel in the adjacent lane in such a way that a uniform distribution results over the entire working width. However, these types of desirable spreading patterns during normal spreading result in an undersupply at the boundary of the field, where spreading takes place only on one side and an overlap therefore does not occur, if spreading takes place only up to the boundary of the field, or it results in overspreading of the boundary beyond the edge of the field and thus to corresponding fertilizer losses. In many cases, an overspreading of this type must be urgently avoided in any case, for example, if the seed or fruit in the neighboring field does not require any nutrient supply or if a waterway or a road runs along the boundary. The same applies to obstacles in the interior of the field which should or may not receive spreading material, such as clusters of trees, bushes, waterways, rock formations, or the like. To ensure a uniform spreading density when spreading along a boundary and to avoid spreading over the boundary, a steeply sloping spreading pattern must be ensured on the boundary side of the twin-disk spreader, while the usual shallow spreading pattern must be retained in the direction of the middle of the field. To effectuate a boundary or edge spreading of this type, for example, so-called boundary spreading devices may be used, which mechanically deflect a portion of the spreading material spun off by the field edge-side spinner disk away from the edge of the field. However, modern twin-disk spreaders often have for this purpose a feed point adjusting device assigned to a particular metering element for moving the feed point of the spreading material to the particular spinner disk, a boundary or edge spreading in this case being able to be ensured in that the rotational speed of the drive of the spinner disk near the boundary is reduced, and/or its feed point is moved, either essentially in the circumferential direction of the boundary-proximate spinner disk against the rotational direction thereof or outwardly essentially in the radial direction of the of the boundary-proximate spinner disk.

DE 10 2005 015 228 A1, which is incorporated herein by reference, relates to a broadcast spreader designed, in particular, as a twin-disk spreader, whose storage container has a container carried by a frame for stockpiling the spreading material, the container comprising an approximately funnel-like, downwardly tapering section, which has an outlet opening, which is fixedly connected to the container. A metering element, below which the spinner disk is supported in a rotationally driven manner around a vertical axis, is situated downstream from the outlet opening of the funnel-like, downwardly tapering section.

The container used for stockpiling the spreading material, which is usually manufactured from metal materials such as steel, is subject to relatively high wear, in particular, in its lower region or on its approximately funnel-like, downwardly tapering section, since, on the one hand, the usually sharp-edged spreading material particles, which slide downwardly along the container walls during operation, cause a mechanical abrasion and, on the other hand, the widely used mineral fertilizers, in particular, have a corrosive effect, which may result in not inconsiderable maintenance costs and even the need to replace the entire container. Moreover, it is often necessary to replace the spreader mechanisms, for example to adapt the broadcast spreader to different spreading materials having very different physical properties, such as very different flowability and/or extremely different flight properties, for example, mineral fertilizer, on the one hand, and lime, on the other hand, which is possible at most only to a limited extend in generic broadcast spreaders.

DE 10 2010 000 296 A1 describes a broadcast spreader, in particular, in the form of a twin-disk spreader, whose storage container has a container carried by a frame for stockpiling the spreading material, the container comprising an approximately funnel-like, downwardly tapering section with an outlet opening. A metering element is situated downstream from the outlet opening of the essentially funnel-like, downwardly tapering section of the container, which directly abuts the funnel-like, tapered section of the container, and under which the spinner disk is located. To protect against corrosion, the container, along with its two outlet funnels, is formed as a single piece from a plastic material, by which, however, limits are imposed on its stability and consequently its holding capacity.

### SUMMARY OF THE INVENTION

It is therefore an object of the present invention to easily and cost-effectively refine a broadcast spreader of the type mentioned at the outset in such a way that a greater maintenance friendliness of the container and, in particular, also an easier replacement of the spreader mechanisms is made possible while at least largely avoiding the aforementioned disadvantages.

According to an example of the invention, this object is achieved in a broadcast spreader of the type mentioned at the outset in that the outlet opening is arranged on a separate outlet part of the container, which is detachable fastened to the essentially funnel-like, downwardly tapering section of the container.

An outlet part may be detachably fastened to the essentially funnel-like, downwardly tapering section of the container and may be easily and cost-effectively replaced in the case of wear without having to uninstall or even replace the entire container during maintenance or repair work. In addition, the accessibility to the spreader mechanisms, which are conventionally usually fastened to the funnel-like, downwardly tapering sections of the container, in particular to the metering elements and possibly to the feed point adjusting device, may be significantly simplified by removing the (particular) outlet part, whereby a simplified replacement of the spreader mechanisms with other spreader mechanisms suitable for different types of spreading material is possible if desired. The example of the container according to the invention also opens up the possibility, in particular, on the part of the manufacturer to only provide different outlet parts for different types of broadcast spreaders without having to change the rest of the container, i.e., only the outlet part needs to be adapted to the particular broadcast spreader, in particular to its spreader mechanisms, while the rest of the container may be manufactured in series production universally for different spreader types.

The outlet part of the container can be manufactured from a plastic material, so that, on the one hand, it is largely inert with respect to chemical attacks of different spreading material types, such as mineral fertilizers, and, on the other hand, has a relatively low weight to ensure an easy handling during installation and removal. Any known, for example fiber-reinforced, polymers may be considered as plastic materials, including thermosetting and thermoplastic polymers, for reasons of an easy manufacturing and, in particular, a good recyclability, thermoplastic polymers, however, being preferred, so that the output part may be advantageously designed in the form of an injection-molded part. Moreover, this also avoids danger of corrosion even to the container, which is usually manufactured from metal materials, since a chemical half-cell is unable to form between the essentially funnel-like, downwardly tapering section of the container and the outlet section fastened thereto when exposed to moisture and salts, as usually occurs during the operation of broadcast spreaders. The same applies to a spreader mechanism fixed to the outlet section of the container.

The outlet part may be detachably fastened to the essentially funnel-like, downwardly tapering section of the container in any known way, for example, in a force-fitting and/or form-fitting manner with the aid of latching, clamping, and/or screw connections.

In this connection, the essentially funnel-like, downwardly tapering section of the container may have, for example, a plurality of container fastener, which are arranged on the circumference of the essentially funnel-like, downwardly tapering section of the container, for example, distributed around the outer circumference of the essentially funnel-like, downwardly tapering section of the container, while the outlet part has outlet part fastener complementary thereto.

The container fastener of the essentially funnel-like, downwardly tapering section of the container may comprise, for example, fastening brackets, which preferably have at least one fastening bore, the outlet part fastener of the outlet part being provided with at least one bore aligned therewith to be able to detachably connect the latter with the fastening bores of the fastening brackets with the aid of screws, bolts, or the like.

To ensure an essentially dust-tight and, in particular, moisture-tight connection between the outlet part of the container and its essentially funnel-like, downwardly tapering section, a sealing ring may also preferably be arranged between the outlet part and the funnel-like, downwardly tapering section of the container, which is inserted, in particular, in a sealing ring receptacle of the outlet part.

While the outlet part of the container may also be designed as a single piece and provided with a base in which the outlet opening is formed, it may be provided according to one advantageous refinement that a base of the outlet part provided with the outlet opening is designed as a separate base part, which is fixed to the outlet part. This provides the possibility of manufacturing the base formed by the separate base part, which is subjected the most to wear, from a particularly wear-resistant and corrosion-resistant material, which simultaneously has a high strength.

The separate base part may therefore be advantageously manufactured from a corrosion-resistant metal material, for example from stainless steel, which moreover has a high strength and stiffness, to be able to securely fasten it to the base part of the outlet part of the container in a manner which is known as such, for example to fasten the metering element to its metering slide and possibly to a feed point adjusting device.

While the separate base part may also be fixedly connected to the outlet part in that, for example, it is injected into the outlet part during its manufacturing, it is provided in an example that the base part is detachably fixed to the outlet part of the container so that it may be easily replaced if necessary, and the accessibility to function parts of the broadcast spreader fastened thereto is facilitated, for example, to the metering slide of the metering element. Moreover, a separate base part detachably connected to the outlet part offers, in particular, the possibility of very easily and cost-effectively adapting the spreader mechanisms of the broadcast spreader to different spreading material types, for example, to relatively coarse particulate and highly flowable mineral fertilizers, on the one hand, and by comparison less flowable lime, on the other hand, in that two or multiple separate base parts are provided, which have different outlet openings adapted to the particular spreading material type and which may then be replaceably and detachably fixed to the outlet part of the container, depending on the spreading material type to be applied.

The base part may thus have, for example, fastening holes which align with holes of the outlet part of the container for the purpose of screwing the base part to the outlet part, the fastening holes of the base part and the holes of the outlet part being able to be arranged distributed around the circumference of the outlet part and the base part.

To make installation easier, the base part may also have at least one centering element, which is complementary to at least one centering element of the outlet part of the container. The fastening holes of the base part used to fasten the base part to the outlet part may thus be arranged, for example, on elevations of the base part, which engage with complementary indentation of the outlet part when the base part has been fixed to the outlet part.

The outlet opening of the base part may be arranged eccentrically in relation to a rotation axis of the spinner disk assigned to this outlet opening in a manner which is known as such, the outlet opening being able to be limited by a boundary-side recess of the base part, on the one hand, and by a circumferential section of the outlet part, on the other hand.

The base part of the outlet part may furthermore have a central through-bore, which is used to support a shaft, which carries an agitator and which may be, in particular, the shaft which carries the spinner disk assigned to the outlet part.

The central through-bore of the base part may be arranged on a flange-like, upwardly protruding projection of the base part, so that a mechanical stiffening of the base part is given, on the one hand, and the spreading material is guided away from the central region of the base part in the direction of the outlet opening, on the other hand.

The outlet part of the container may furthermore have a circular segment-shaped outer circumferential section, which is used as a guide for a feed point adjusting device, which—as mentioned above—may be arranged on the underside of the base part as part of a spreader mechanism.

Moreover, it may be provided that the outlet part of the container has a graduation identifying the position of a metering slide of the metering element and/or the feed point adjusting device, which may be injected into or onto the outlet part designed as an injection-molded part.

The container can have, on the one hand, a container upper part and, on the other hand, at least one container lower part to which the outlet part of the container is fastened and forms at least one separate lower region of the essentially funnel-like, downwardly tapering section of the container, which is preferably detachably fastened thereto. In this case, the container therefore comprises the container upper part, on the one hand, and the container lower part, on the other hand, including the essentially funnel-like, downwardly tapering section(s) as well as the outlet part detachably fastened thereto. A container designed in this way offers an even greater modularity, in that the container upper part may be universally used by the manufacturer, for example, for a multiplicity of different broadcast spreader types, while the container lower part or the outlet part may be adapted to the particular spreader type or to the particular spreader mechanism.

The container upper part and/or the container lower part, which may be designed, for example, in the form of a deep-drawn part, are preferably manufactured from a metal material for stability reasons, at least the component lower part exposed to greater wear, in particular, being able to be advantageously manufactured from stainless steel.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic rear view of an example of a broadcast spreader according to the invention in the form of a twin-disk spreader;

FIG. 2 shows a schematic top view of the container of the broadcast spreader according to FIG. 1;

FIG. 3 shows a schematic exploded representation of the container according to FIG. 2 as well as a spreader mechanism and the spinner disks;

FIG. 4 shows a schematic perspective detailed view of the container lower part of the container according to FIG. 2;

FIG. 5 shows a schematic exploded representation of an outlet part of the container, including its base part, according to FIG. 2;

FIG. 6 shows a schematic perspective detailed view of the outlet part, including the base part, according to FIG. 5, viewed at an angle from above;

FIG. 7 shows a schematic perspective detailed view of the outlet part, including the base part, according to FIGS. 5 and 6, viewed at an angle from below;

FIG. 8 shows a schematic perspective detailed view of the outlet part according to FIGS. 5 through 7, without the base part, viewed at an angle from above;

FIG. 9 shows a schematic perspective detailed view of the outlet part according to FIGS. 5 through 8, without the base part, viewed at an angle from below;

FIG. 10 shows a schematic detailed view of the base part of the outlet part according to FIGS. 5 through 7;

FIG. 11 shows a schematic sectional view to illustrate the detachable fastening of the outlet part to the container lower part of the container; and

FIG. 12 shows a further schematic sectional view to illustrate the detachable fastening of the outlet part to the container lower part of the container.

### DETAILED DESCRIPTION

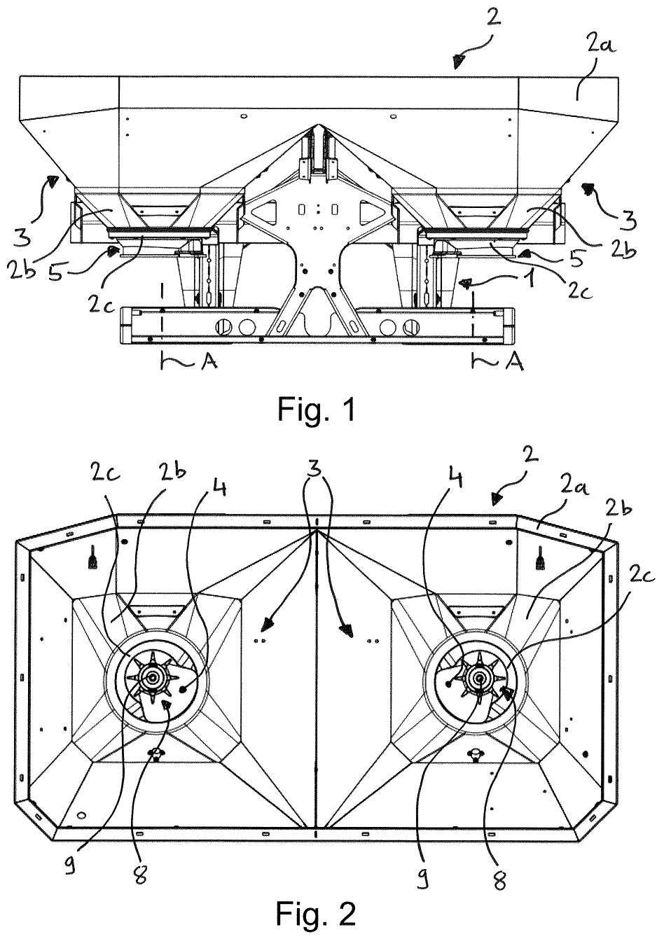

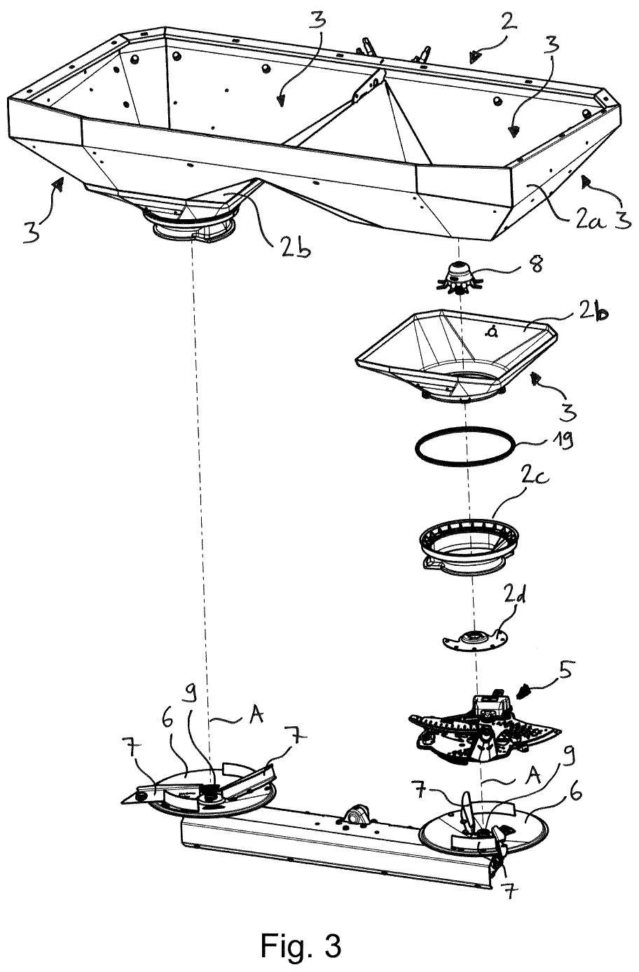

The broadcast spreader schematically illustrated in FIG. 1 is designed in the form of a twin-disk spreader for agricultural purposes and is used to apply powdery or particulate spreading material, for example fertilizer or seeds. The broadcast spreader has a container 2 carried by a frame 1, which is used to stockpile the powdery or particulate spreading material. Container 2 in the present case comprises two essentially funnel-like downwardly tapering sections 3, each of which has an outlet opening 4, which is not apparent in FIG. 1, at its lower end (cf., for example, FIG. 2). A metering element 5, which is apparent only in FIGS. 1 and 3 and is known as such from the prior art, is situated directly below a particular outlet opening 4 and comprises in each case a metering slide, which interacts with a particular outlet opening 4, the metering slide of the two metering elements 5 being able to be controlled and/or regulated preferably independently of each other to be able to adjust a mass flow of spreading material corresponding to the particular setpoint spreading material quantity. As is apparent in FIG. 3, a spinner disk 6 situated below each particular metering element 5 (omitted in FIG. 1 for reasons of clarity) is rotatably supported around a vertical axis A in each case, spinner disks 6 being fitted with throwing blades 7 in the usual manner. Spinner disks 6 provided with throwing blades 7 are rotationally driven in opposite directions with the aid of suitable drives, the drives being able to be, for example, electric or hydraulic motors (not illustrated), which may be speed-controlled preferably independently of each other. As is again apparent in FIG. 1, the twin-disk spreader in the present case is designed as a piece of accessory equipment, whose frame 1 comprises a fastening device (not illustrated) on its front side (viewed in the direction of travel), which is not visible in FIG. 1 and which is used to receive the twin-disk spreader with the aid of the three-point power lift of a traction engine (also not illustrated), such as a tractor. It is also apparent from FIGS. 2 and 3 that an agitator 8 is arranged above a particular outlet opening 4 of container 2, which is supported coaxially to a particular spinner disk 6 on a shaft 9 carrying the latter and has an agitator drive, which is not apparent in the drawing.

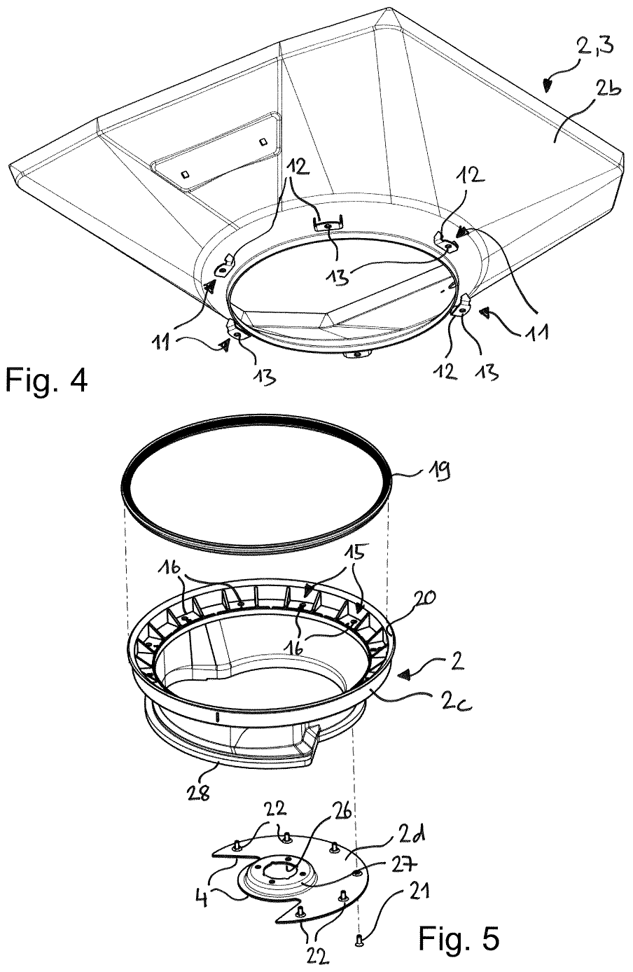

As is apparent, in particular, from FIGS. 3 and 4, but also from FIG. 1 and 2, container 2 of the broadcast spreader is provided with a multi-part design and comprises, on the one hand, a container upper part 2a, which limits an approximately rectangular upper opening edge of container 2, and comprises the upper regions of the two approximately funnel-like, downwardly tapering sections 3 of container 2, and, on the other hand, two separate container lower parts 2b (also cf. the detailed view in FIG. 4), which are detachably fixed to container upper part 2a, for example by means of screws, and which comprise the lower regions of the two approximately funnel-like, downwardly tapering sections 3 of container 2. Upper container part 2a and lower container parts 2b are manufactured, for example, from a metal material, such as steel, at least lower container parts 2b preferably being able to be manufactured from stainless steel.

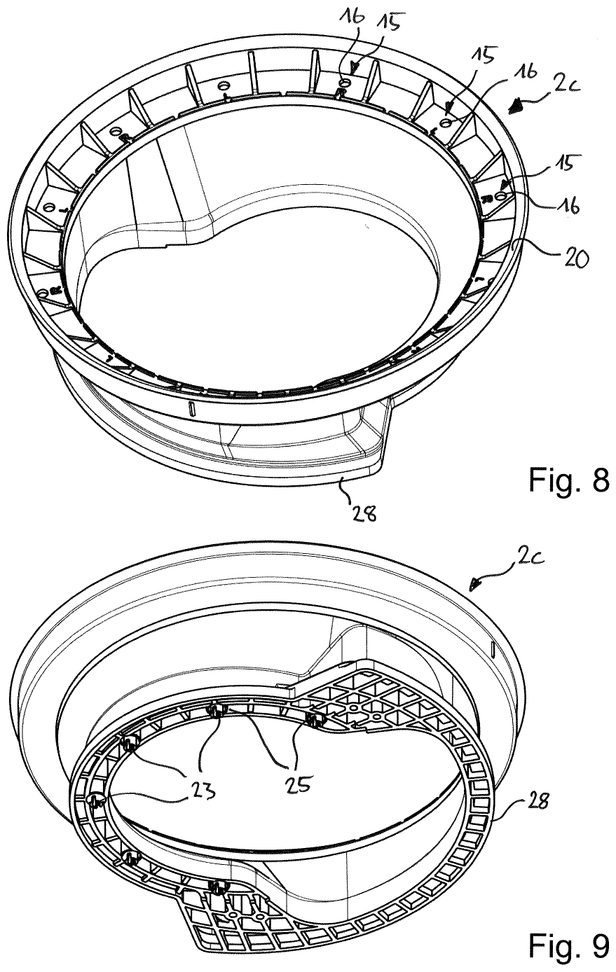

A separate outlet part 2c of container 2, which in the present case is manufactured as an injection-molded part from a thermoplastic plastic material, is detachably fastened to a particular one of the two essentially funnel-like, downwardly tapering sections 3 of container 2—or more specifically to a particular container lower part 2b thereof—and has a separate base part 2d provided with outlet opening 4 and made from a wear-resistant and corrosion-resistant metal material, for example from stainless steel, which is detachably fixed to outlet part 2c of container 2 (cf., in particular, FIG. 3 as well as FIGS. 5 through 9). A particular outlet part 2c of container 2 is detachably fastened to a particular approximately funnel-like, downwardly tapering container lower part 2b of container 2 in a force- and form-fitting manner, using a plurality of screws 14 (cf. the sectional views in FIGS. 11 and 12), container lower parts 2b, which taper downwardly in an essentially funnel-like manner, being equipped for this purpose with a plurality of container fastener 11, which are arranged on the outer circumference of a particular approximately funnel-like, downwardly tapering container lower part 2b, and in the example illustrated in the drawing are formed by approximately U-shaped fastening brackets 12, whose U leg is fastened, for example welded, to the outer circumference of a particular container lower part 2b and whose U web is provided with a fastening bore 13 (cf., in particular, FIG. 4). A particular outlet part 2c is equipped with outlet part fastener 15, which are complementary to fastening bores 13 of container fastener 11 of container lower parts 2b and, in turn, are formed by bores 16 which align with the fastening bores of container fastener 11 for the purpose of connecting them with the aid of screws 14. As is apparent in FIGS. 11 and 12, it may be provided for the purpose of easy installation, for example, that screws 14 are in engagement with polygon nuts 17, which are introduced between the U webs of fastening brackets 12 of container fastener 11 of a particular container lower part 2b by means of an anti-rotation device 18. As is apparent from FIGS. 3 and 5, a sealing ring 19, which is inserted into a sealing ring receptacle 20 of outlet part 2c and ensure a dust- and moisture-tight seal, may be arranged between a particular outlet part 2c of container 2 and a particular container lower part 2b, which forms the lower region of a particular essentially funnel-like, downwardly tapering section of container 2.

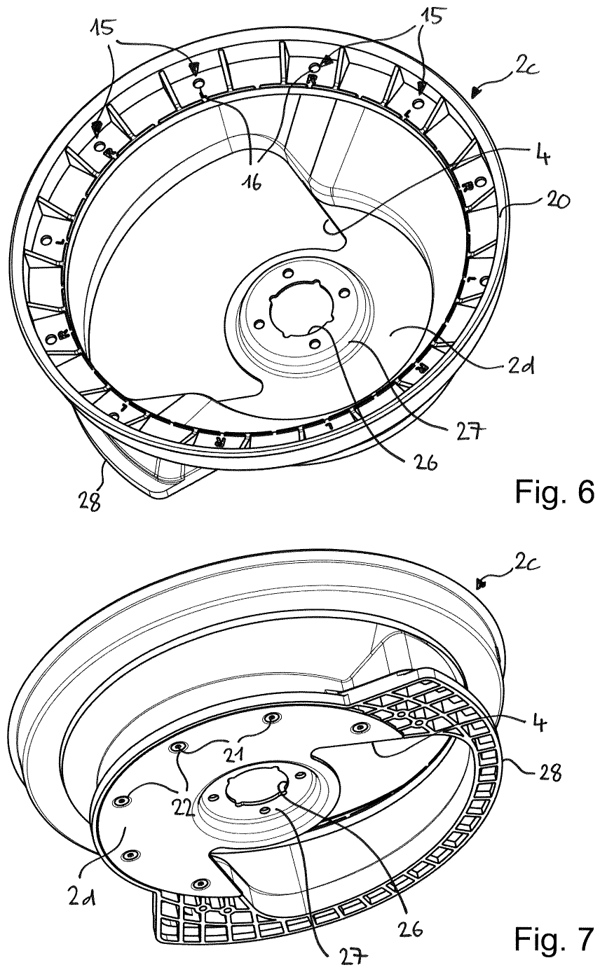

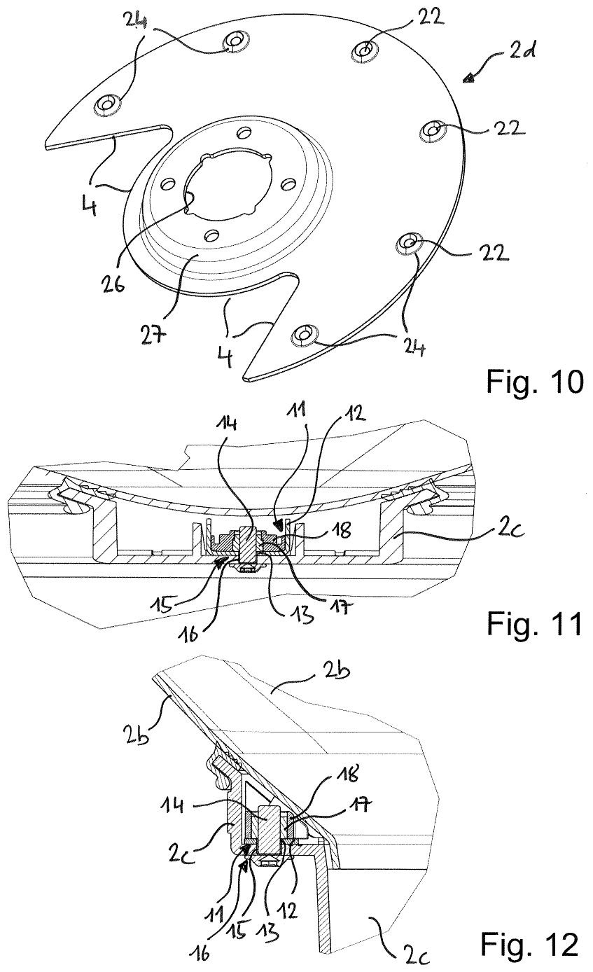

A particular base part 2d is also detachably fixed to the lower side of a particular outlet part 2c of container 2 opposite a particular container lower part 2b, which, in turn, may take place with the aid of screws 21 (cf. FIGS. 5 and 7), which pass through fastening holes 22 of base part 2d, on the one hand, and holes 23 aligned therewith of outlet part 2c of container 2, on the other hand (cf. FIGS. 5, 7, 9, and 10). In the present case, base part 2d furthermore comprises a centering element in the form of elevations 24, which are formed out of the plane of base part 2d, for example surrounding a particular fastening hole 22 (cf. FIG. 10), and are complementary to a centering element of outlet part 2c of container 2 in the form of indentations 25, which are formed on the underside of outlet part 2c facing base part 2d, for example surrounding a particular hole 23 (cf. FIG. 9). In the present case, a particular outlet opening 4 of a particular base part 2d of container 2 is arranged eccentrically with respect to rotation axis A of spinner disk 6 assigned to particular outlet opening 4, outlet opening 4 being limited by an edge-side recess of base part 2d, on the one hand, and by a circumferential section of outlet part 2c, on the other hand (cf., in particular, FIGS. 6 and 7. In its central region, base part 2d of a particular outlet part 2c is provided with a central through-bore 26, which is arranged, for example, on a flange-like, upwardly protruding projection 27 of base part 2d and is used to support shaft 9 carrying agitator 8 (cf. FIG. 3). Moreover, a particular outlet part 2c of container 2 is equipped with a circle segment-shaped outer circumferential section 28, which is used as a guide for a feed point adjusting device, which is not illustrated in the drawing and operates in the circumferential direction of a particular spinner disk 6, as is known as such from the prior art, reference being hereby made by way of example to EP 1 738 632 A1.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A broadcast spreader for applying spreading material, the broadcast spreader comprising:
at least one container carried by a frame to stockpile the spreading material, the container having at least one essentially funnel-like, downwardly tapering section with at least one outlet opening;
at least one metering element arranged downstream from the outlet opening; and
at least one spinner disk arranged downstream from the metering element,
wherein the outlet opening is arranged on a separate outlet part of the container, which is detachably fastened to the essentially funnel-like, downwardly tapering section of the container.

2. The broadcast spreader according to claim 1, wherein the outlet part is manufactured from a plastic material and designed in the form of an injection-molded part.

3. The broadcast spreader according to claim 1, wherein the outlet part is detachably fastened in a force-fitting and/or form-fitting manner to the essentially funnel-like, downwardly tapering section of the container.

4. The broadcast spreader according to claim 1, wherein the essentially funnel-like, downwardly tapering section of the container has a plurality of container fasteners, which are arranged on the circumference of the essentially funnel-like, downwardly tapering section of the container, and wherein the outlet part has outlet part fasteners which are complementary thereto.

5. The broadcast spreader according to claim 4, wherein the container fasteners comprise fastening brackets, and/or have at least one fastening bore, and the outlet part fasteners are provided with at least one bore aligned therewith.

6. The broadcast spreader according to claim 1, wherein a sealing ring, which is inserted into a sealing ring receptacle of the outlet part, is arranged between the outlet part of the container and the container's essentially funnel-like, downwardly tapering section.

7. The broadcast spreader according to claim 1, wherein a base of the outlet part provided with the outlet opening is a separate base part, which is fixed to the outlet part.

8. The broadcast spreader according to claim 7, wherein the base part is manufactured from a metal material or from stainless steel.

9. The broadcast spreader according to claim 7, wherein the base part is detachably fixed to the outlet part of the container, the base part comprising fastening holes, which align with holes of the outlet part of the container for the purpose of screwing the base part to the outlet part and/or comprising at least one centering element, which is complementary to at least one centering element of the output part of the container.

10. The broadcast spreader according to claim 7, wherein the outlet opening of the base part is arranged eccentrically in relation to a rotation axis of the spinner disk assigned to this outlet opening, the outlet opening being limited by an edge-side recess of the base part and by a circumferential section of the outlet part.

11. The broadcast spreader according to claim 7, wherein the base part also has a central through-bore, which is used to support a shaft carrying an agitator, the central through-bore of the base part being arranged on a flange-like, upwardly protruding projection of the base part.

12. The broadcast spreader according to claim 1, wherein the outlet part of the container has a circle segment-shaped outer circumferential section, which is used as a guide for a feed point adjusting device.

13. The broadcast spreader according to claim 1, wherein the outlet part of the container has a graduation identifying the position of a metering slide of the metering element and/or the feed point adjusting device, which may be injected into or onto the outlet part designed as an injection-molded part.

14. The broadcast spreader according to claim 1, wherein the container has a container upper part and at least one separate container lower part fastened thereto, to which the outlet part of the container is detachably fastened and forms at least one lower region of the essentially funnel-like, downwardly tapering section of the container, the at least one container lower part being in the form of a deep-drawn part and/or detachably fastened to the container upper part.

15. The broadcast spreader according to claim 14, wherein the container upper part and/or the container lower part are manufactured from a metal material or from stainless steel.
